(19) United States
(12) Patent Application Publication
(10) Pub. No.: US 2002/0008771 A1
(43) Pub. Date: Jan. 24, 2002

(54) Digital camera and image processing apparatus

(76) Inventors: Fumiko Uchino, Otokuni-gun (JP); Kenji Masaki, Nagaokakyo-shi (JP); Naoko Hiramatsu, Kyoto-shi (JP); Satoshi Deishi, Ibaraki-shi (JP)

Correspondence Address: Barry E. Bretschneider, Morrison & Foerster LLP, Suite 5500, 2000 Pennsylvania Avenue, N.W., Washington, DC, 20006-1888, US

(21) Appl. No.: 09/828,787

(22) Filed: Apr. 10, 2001

(30) Foreign Application Priority Data
Apr. 13, 2000 (JP) P2000-111704

(51) Int. Cl. H04N 5/238

(52) U.S. Cl. 348/362; 348/364

(57) ABSTRACT

A digital camera has a correcting process determining section for determining an image correcting process in accordance with the metering type uses in capturing the image. In the case where spot metering is performed, a correcting process for making a metering area proper is determined, thereby making an image correction in which intention of the user is reflected. In the case where multi-area metering is performed, a metering value and a result of scene determination are transferred from an exposure determining section to a correction controlling section. By using the information obtained in the metering process also for the image correction, the correction time can be shortened.

This application is based on application No. 2000-111704 filed in Japan, the contents of which are hereby incorporated by reference.

### BACKGROUND OF THE INVENTION

1. Field of the Invention

The present invention relates to a technique of performing a process on an image captured by a digital camera or the like. The digital camera may be a digital still camera or a digital movie camera.

2. Description of the Background Art

Conventionally, an image process is performed on an image captured by a digital camera or the like to correct the hue and contrast of the image. A technique of dividing an image into a plurality of areas at the time of image correction, determining an image pickup environment from brightness and a color average value of each divided area, and correcting the image more properly by using the result of determination is also proposed.

On the other hand, at the time of capturing an image, metering process for measuring brightness of an object is conducted to determine exposure parameters such as an F-number (aperture) and exposure time. The types of metering are broadly classified into a method of metering the brightness only in a specific area in an image capturing range (hereinbelow, called “spot metering”) and a method of metering the brightness in a plurality of areas within an image capturing range (hereinbelow, called “multi-area metering”). There is a case that the multi-area metering uses a method of determining image capturing environment by using measurement values in the respective areas. As described above, in a digital camera, various measurement results and determination results related to metering are obtained at the time of determining exposure parameters.

For example, as described in Japanese Patent Application Laid-Open No. 10-191246(1998), which corresponds to U.S. Pat. No. 6,011,547, a technique of utilizing information used for determining exposure parameters to correct the captured image has been proposed. The publication discloses that a process performed in the multi-area metering or parameters used for a process are stored and the information is utilized to make an image correction intended by the user.

There is, however, a variety of information to determine exposure parameters. It cannot be said that information provided at the time of image capturing is sufficiently utilized when the intention of the user is reflected by simply using a process or parameters in multi-area metering. Particularly, the metering provides information exerting a large influence on a process of correcting an image. Further, a metering result and a determination result obtained in the case of multi-area metering have commonality with information used to correct an image captured.

### SUMMARY OF THE INVENTION

The present invention is directed to a digital camera. According to the present invention, the digital camera comprises: an image pickup device for capturing an image of a subject; an exposure determining element for determining exposure parameters in image capturing; a selector for selecting a metering process for determining the exposure parameters; and a corrector for correcting the image through a correcting process according to a type of the metering process selected by the selector.

Preferably, the corrector is operable to correct the image on the basis of values of pixels correcting to a specific area within an image capturing range, when the metering process selected for the image is a first metering type in which brightness in the specific area is weighted within the image capturing range.

The corrector may be operable to correct the image on the basis of either a result of the metering process or information lead from the result of the metering process, when the metering process selected for capturing the image is a second metering type in which a plurality of areas within the image capturing range are metered.

In a preferred embodiment of the present invention, the exposure determining element determines a relation between a distribution of brightness in the image and the subject on the basis of the result of the metering process to make scene determination, and the corrector corrects the image on the basis of a result of the scene determination.

The present invention is also directed to an apparatus for processing an image. According to the present invention, the apparatus comprises: a first element for determining a metering type used in capturing the image from image data including the image and determining a correcting process in accordance with the metering type; and a second element for correcting the image through the correcting process.

The digital camera and/or the apparatus may operate in accordance with software programs which are stored in storage or installed through a network.

In an aspect of the present invention, an image processing system comprises: an image camera for capturing an image of a subject; a metering device for metering the subject for exposure control at capturing, and provided with a plurality of metering processes; a program storage for storing a plurality of image-correction programs previously related, respectively; a selector for selecting a metering process among the plurality of metering processes to activate the metering device in accordance with the metering process selected: and an image-corrector for correcting the image according to an image-correction program previously related to the metering process.

In another aspect of the present invention, an image processing system comprising: an image camera for capturing an image of a subject; a metering device for metering the subject for exposure control to generate a metering information; and an image-corrector for correcting the image in response to the metering information obtained in the metering device.

It is therefore an object of the invention to overcome the problems caused in the background arts.

It is another object of the invention to make an appropriate image correction by effectively utilizing information obtained in metering process also for correcting an image.

It is another object of the invention to effectively utilizing exposure parameters determined in metering process.

Another object of the invention is to shorten time required to correct an image.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing the appearance of the front side of a digital camera according to a preferred embodiment of the invention;

FIG. 2 is a perspective view showing the appearance of the rear side of the digital camera;

FIG. 3 is a block diagram showing main components of the digital camera;

FIG. 4 is a diagram for explaining a metering;

FIG. 5 is a block diagram showing the functional configuration and the like of the digital camera;

FIGS. 6 and 7 are flowcharts showing the flow of an image capturing operation of the digital camera;

FIG. 8 is a flowchart showing another example of step S25 in FIG. 7;

FIG. 9 is a diagram showing a state where an image is divided on the basis of the position of a metering area;

FIG. 10 is a flowchart showing the flow of correcting a divided area;

FIGS. 11 and 12 are diagrams for explaining a specific example of correction by the digital camera when multi-area metering is carried out;

FIG. 13 is a flowchart showing further another example of step S25 in FIG. 7;

FIG. 14 is a system diagram showing an image processing apparatus and a digital camera according to another preferred embodiment of the invention;

FIG. 15 is a block diagram showing the internal configuration of a computer;

FIG. 16 is a diagram showing the structure of image data; and

FIGS. 17 to 19 are block diagrams showing various information and the functional configuration of the computer.

### DESCRIPTION OF THE PREFERRED EMBODIMENTS

1. First Preferred Embodiment

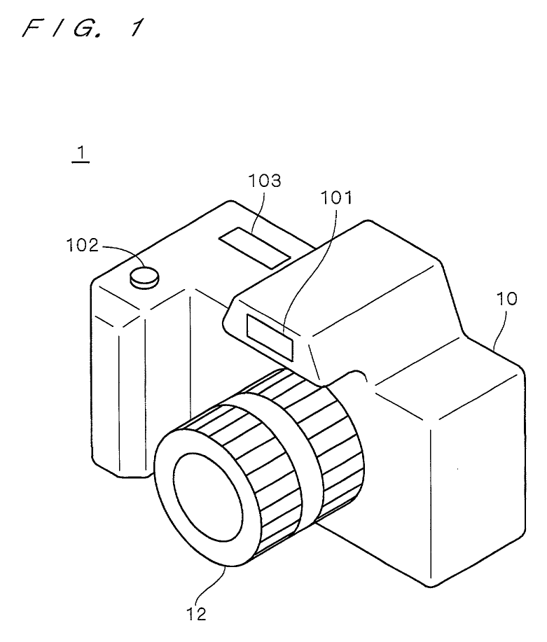

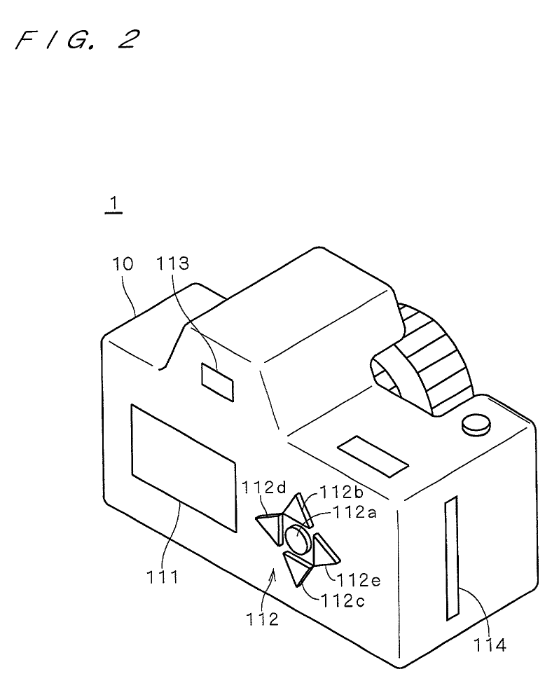

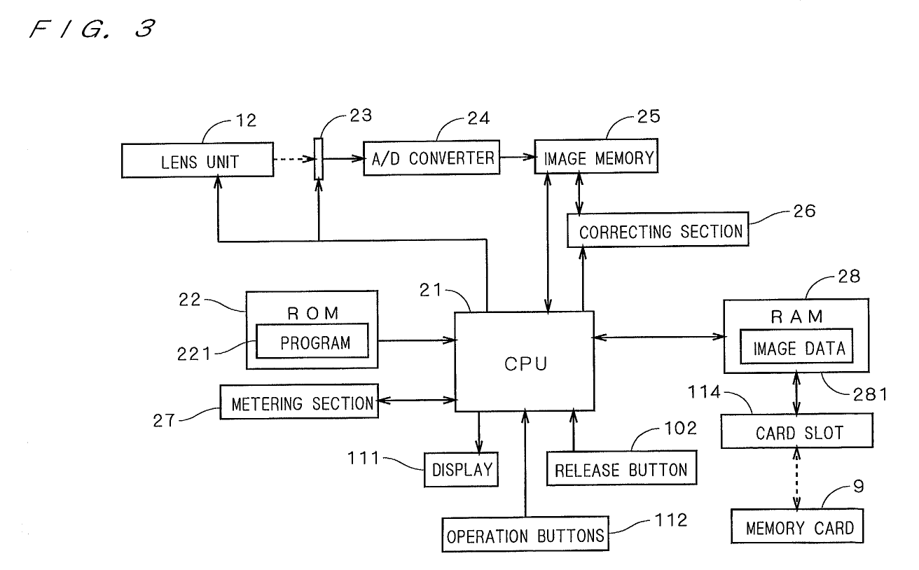

FIG. 1 is a perspective view showing the appearance of the front side of a first digital still camera 1 according to a preferred embodiment of the invention. FIG. 2 is a perspective view showing the appearance of the rear side of the digital camera 1.

As shown in FIG. 1, the digital camera 1 has a structure that a detachable lens unit 12 is attached to a camera body 10. In the front upper part of the camera body 10, a flash unit 101 is provided to emit flash light as necessary toward a subject. On the top face, a release button 102 for allowing the digital camera 1 to perform an image capturing operation and a simple display 103 for displaying the frame number at the time of image capturing, setting in various operation modes, and the like are provided.

The lens unit 12 has a configuration that a plurality of lens elements are held by a lens barrel. Optical system constructed by the plurality of lens elements lead light from the subject to a CCD provided as a solid-state image pickup device in the camera body 10. Consequently, an image of the subject is formed on the CCD. The lens unit 12 also has therein a driving mechanism for moving lenses and an aperture.

As shown in FIG. 2, on the rear face of the camera body 10, a display 111 for displaying a captured image, an operation menu, and the like and operation buttons 112 for performing an operation in accordance with information displayed on the display 111 are disposed. The operation buttons 112 include a center button 112a, and an upper button 112b, a lower button 112c, a left button 112d, and a right button 112e which are disposed on the upper, lower, left, and right sides of the center button 112a, respectively.

An optical viewfinder 113 used by the user to find the subject is provided on an upper part of the rear face, and a slit-shaped card slot 114 to which a memory card as an external recording medium is inserted is provided on a side of the camera body 10.

At the time of capturing an image, the operating mode of the digital camera 1 is switched to an image capturing mode, and images of the subject continuously captured by the CCD are displayed as live view. The image capturing range may be checked through the finder 113. When the user presses the release button 102 to half stroke, preparation for image capturing such as focus lock is made. When the user presses the release button 102 to full stroke, the image capturing and recording operation is executed. In the image capturing mode, when the upper button 112b is pressed, the lens is moved to the telescopic side. When the lower button 112c is pressed, the lens is moved to the wide side.

At the time of playing back an image, the operating mode of the digital camera 1 is switched to a playback mode, and an image captured is displayed on the display 111. By pressing the upper button 112b in the operation buttons 112, recorded images are played back and displayed in forward order. By pressing the lower button 112c, the recorded images are played back and displayed in the opposite order. In the playback mode, as necessary, a plurality of captured images are displayed as thumbnail images on the display 111. An image is temporarily selected by using the upper, lower, left, and right buttons 112b to 112e. By pressing the center button 112a, the selected image is enlarged and displayed.

FIG. 3 is a block diagram showing the configuration of the digital camera 1. As shown in FIG. 3, in the digital camera 1, various components are electrically connected to a CPU 21, so that the CPU 21 controls the whole operation of the digital camera 1. In FIG. 3, components other than the major components connected to the CPU 21 are not shown.

An operation program 221 for the digital camera 1 is stored in a ROM 22 connected to the CPU 21. The CPU 21 performs a computing and control process in accordance with the program 221, thereby realizing the operation of the digital camera 1.

On a photoreceiving surface of a CCD 23, an image of the subject is formed via the optical system in the lens unit 12, and an image signal for forming an image of the subject is outputted from the CCD 23. The image signal from the CCD 23 is converted by an A/D converter 24 to a digital signal and the digital signal is stored in an image memory 25.

A correcting section 26 corrects the hue, contrast, and the like of an image (to be accurate, an image signal, but will be referred to as an “image” as appropriate in the following description) recorded in the image memory 25.

A metering section (photometering section) 27 measures the brightness of the subject. A measurement value (hereinbelow, called a “metering value”) as a metering result is used to calculate the exposure parameters such as exposure time and an F-number by the CPU 21. At the time of capturing an image, lens driving and aperture in the lens unit 12, and exposure time of the CCD 23 are controlled by the CPU 21 on the basis of the exposure parameters and a signal from an AF sensor (not shown).

A header or the like is properly added to an image held in the image memory 25 by the user and a resultant image is stored as image data 281 in a RAM 28. Further, the image data 281 stored in the RAM 28 can be transferred to a memory card 9 via the card slot 114. Consequently, the image data 281 can be read by a computer separately provided.

In the digital camera 1, the metering type at the time of image capturing can be switched between the spot metering and the multi-area metering by using the operation buttons 112. The spot metering in the digital camera 1 denotes a method of measuring the brightness in a central portion in the image capturing range. The multi-area metering denotes a method of measuring the brightness in a plurality of areas in the image capturing range.

The switch between the spot metering and the multi-area metering is performed by, first, displaying a menu on the display 111 by the operation of the operation buttons 112 and selecting one of a plurality of items indicative types of the metering. The operation buttons 112 also function as means for switching the metering type.

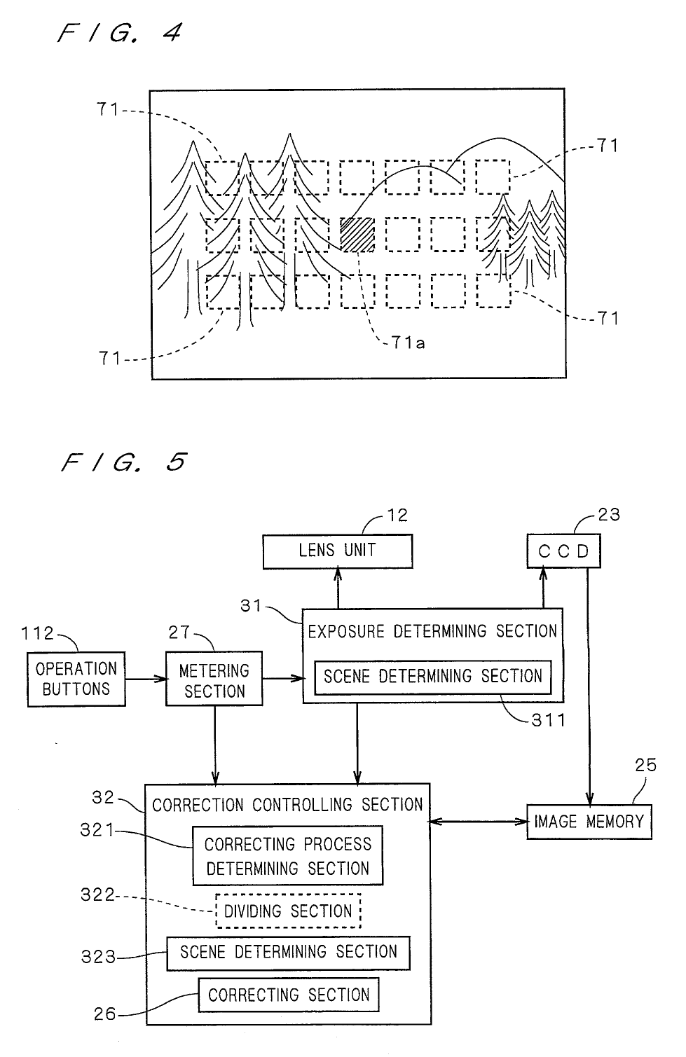

FIG. 4 is a diagram showing a state of spot metering and multi-area metering in the digital camera 1. As shown in FIG. 4, a plurality of metering areas 71 are preset in the image capturing range (that is, in an image to be captured). In the case of the spot metering, the brightness in a center metering area 71a (hatched area) is measured by the metering section 27. In the case of the multi-area metering, the brightness of all the metering areas 71 is measured by the metering section 27. A metering value of each metering area 71 is obtained as an average value of brightness of pixels corresponding to the metering area 71. That is, the CCD 23 and the metering section 27 for performing a computing process function as means for measuring the brightness.

FIG. 5 is a block diagram showing a functional configuration realized when the CPU 21 in the digital camera 1 performs a computing process in accordance with the program 221. In FIG. 5, an exposure determining section 31 and a correction controlling section 32 have the function realized by the CPU 21 and the like. All or a part of the functions may be realized by a dedicated electric circuit in place of CPU 21. Specifically, as shown in FIG. 3, (a part of) the correcting section 26 may be provided as a dedicated electric circuit separate from the CPU 21. All or a part of the other functional components may be realized by a dedicated electric circuit. In FIG. 3, similarly, all or a part of the metering section 27 shown as a separate section from the CPU 21 may be realized by the CPU 21 and the like.

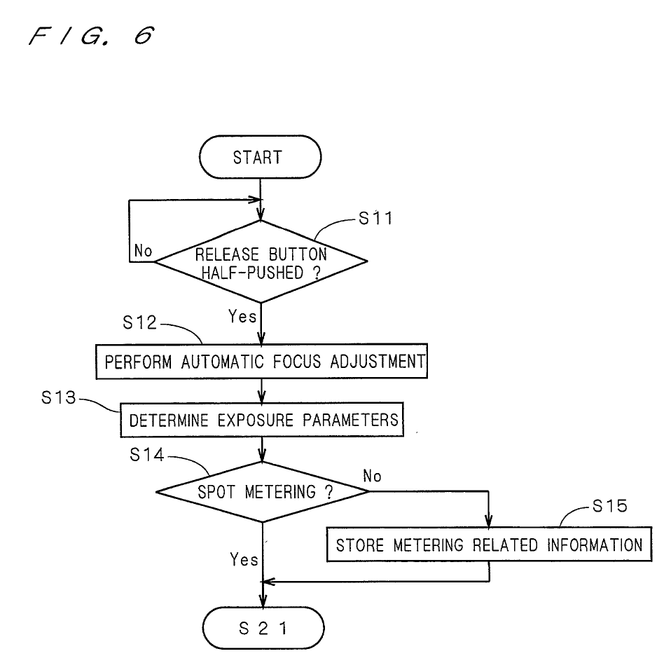

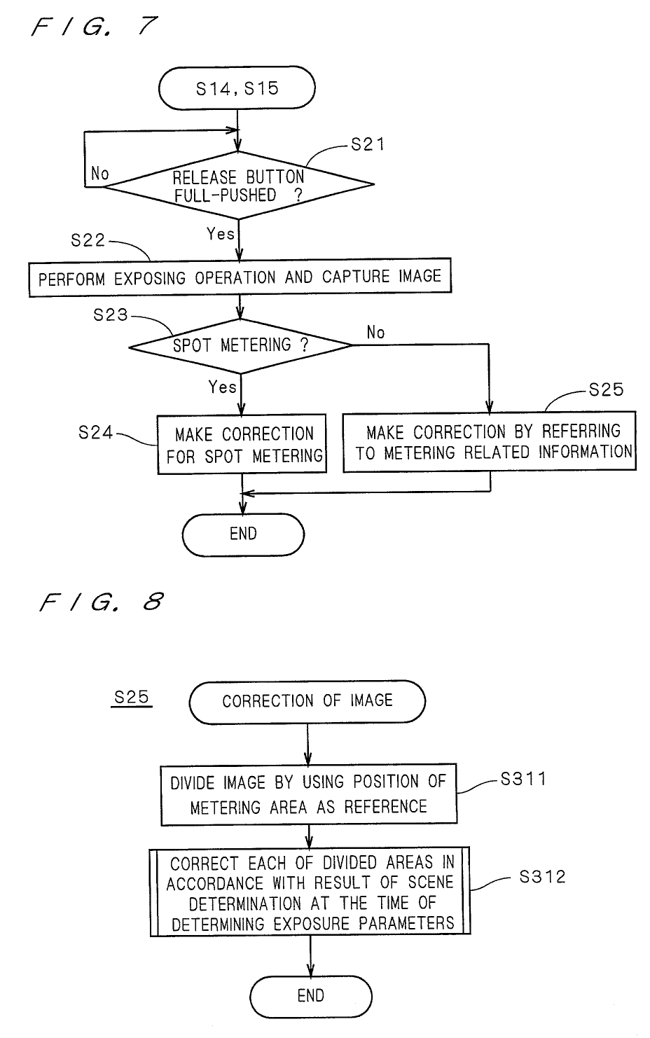

FIGS. 6 and 7 are a flowchart showing the flow of operations of capturing an image of the digital camera 1. With reference to FIGS. 4 to 7, the operations of the digital camera 1 will be described hereinbelow.

In the image capturing mode, live view display is performed in such a manner that an image captured by the CCD 23 is transferred to the display 111 and an image displayed on the display 11 is updated almost real time. Consequently, the user can capture the subject while watching the display 111. The subject may be also captured via the optical viewfinder 113.

After the subject and the image capturing range are determined, the user half-pushes the release button 102 (step S11), thereby controlling the lens movement on the basis of the measurement value from the AF sensor, and automatic focus adjustment is carried out (step S12). Further, the metering section 27 measures brightness by the metering preset by the operation buttons 112, and the exposure determining section 31 determines the exposure parameters such as F-number and exposure time on the basis of the result of the metering (step S13).

In the case where the multi-area metering is performed, by executing a predetermined algorithm on a plurality of metering values, a scene determining section 311 in the exposure determining section 31 performs scene determination of determining the relation between distribution of brightness in the image being captured and the type of the subject. Specifically, a check is made to determine whether the scene is an enlarged scene of a subject, a special scene such as night scene, an indoor scene, a backlight scene, or others. The exposure determining section 31 determines the exposure parameters on the basis of the result of the scene determination.

In the case of the multi-area metering, further, at least one of:

1) metering values of the metering areas 71; and

2) the scene determination result derived from the metering values, s stored as metering related information (steps S14 and S15). The item of the metering related information to be stored is appropriately determined according to a correcting process which will be described hereinlater.

After that, by full-pressing the release button 102 (step S21), charge accumulation of the CCD 23, that is, the exposing operation is executed, and an image of the subject is stored in the image memory 25 (step S22). Subsequently, a correcting process determining section 321 in the correction controlling section 32 receives the information as to the metering type just used from the metering section 27 to confirm whether the metering type is the spot metering or the multi-area metering (step S23). In the case of the spot metering, image correction adapted to the spot metering is made by the correcting section 26 (step S24). In the case of the multi-area metering, another image correction is made by referring to the metering related information (step S25). That is, in the digital camera 1, the correcting process determining section 321 determines the correcting process according to the metering type and, the correcting section 26 corrects an image in accordance with the correcting process determined.

In the digital camera 1, the brightness in the metering area 71 in the central area of the image is measured through the spot metering as shown in FIG. 4. Such metering is used when the user places importance on the central area such as a case where the main subject is positioned in the center of the image. In the correction adapted to the spot metering, therefore, image correction to optimize the hue and contrast in the metering area 71 a is made to reflect the intention of the user.

Whether skin colors exist in the metering area 71 a and its vicinity or not is also determined. When yes, image correction adapted to a human is made in the center area. Specifically, in the case where skin colors exist in the center area and its vicinity in the image at the time of spot metering, the scene determining section 323 in the correction controlling section 32 determines that the possibility that the image is an image of a human is high. The correcting section 26 makes image correction so as not to exceed a predetermined degree of contrast in accordance with the result of scene determination, thereby preventing a skin color from being undesirably corrected to a grained image.

When the correcting process determining section 321 confirms that the multi-area metering was conducted at the time of image capturing, the result of the scene determination made to determine the exposure parameters (hereinbelow, called “scene determination for exposure”) is directly used for the image correction. That is, when “backlight” is determined by the scene determination for exposure, image correction of making a dark area light and increasing the contrast, i.e., enhancing gradation steps, is made. When “night scene” is determined, image correction of increasing the contrast in the entire image or the like is made. It eliminates the need to restart the full process of the scene determination for the image correction. It is unnecessary to completely omit the full process of the scene determination at the time of image correction (hereinbelow, called “scene determination for image correction”). The scene determination for image correction may be simplified by using the result of the scene determination for exposure. In this case as well, time required for image correction is shortened. After completion of the image correction, the metering related information stored may be properly erased.

For the image correction in the case where the multi-area metering is made, the plurality of metering values used at the time of determining the exposure parameters may be used. FIG. 8 is a flowchart showing, as another example of step S25, the flow of image correction in the case where the result of the scene determination for exposure and the metering value as the metering result are used.

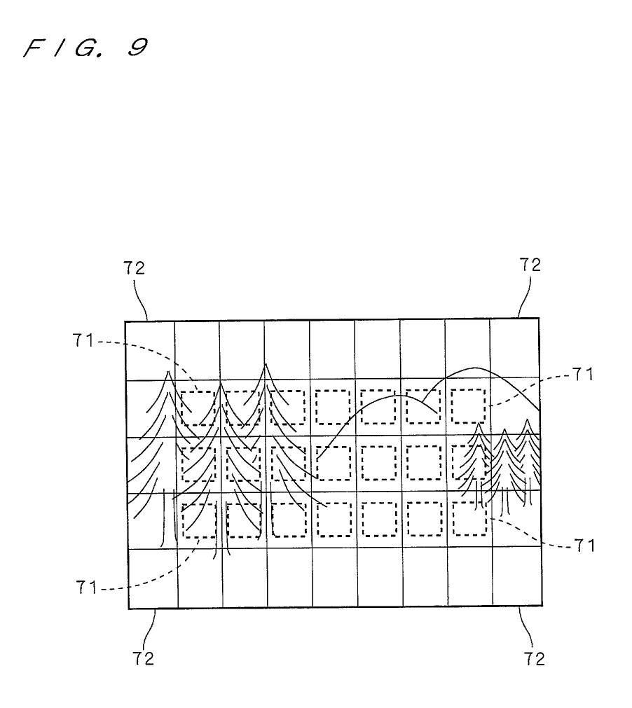

In the case of using the metering values, first, by a dividing section 322 in the correction controlling section 32, as shown in FIG. 9, an image captured is divided into a plurality of divided areas 72 by using the position of the metering areas 71 as a reference position (step S311). Each of respective images in the divided areas 72 is corrected by the correcting section 26 by using the metering values in accordance with the result of the scene determination for exposure (step S312).

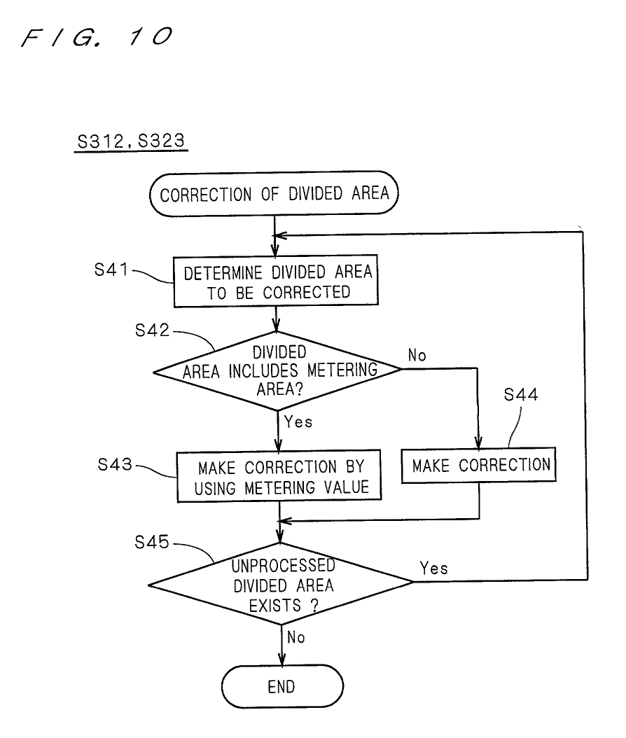

FIG. 10 is a flowchart showing the flow of processes for correcting each of the images in the divided areas 72 by using the metering values. In the correction of each image of the divided areas 72, first, one divided area 72 to be corrected is determined (step S41), and whether the divided area 72 is a divided area including the metering area 71 or not is checked (step S42). In the case where the divided area 72 includes the metering area 71, by using the metering value obtained from the metering area 71, whether image correction is necessary or not and what kind of image correction is to be made is determined. When image correction is necessary, image correction is made (step S43). When the divided area 72 does not include the metering area 71, a computing process is performed by using the respective values of the pixels in the divided area 72 to determine whether image correction is necessary or not and, further, what kind of image correction is to be made is. After that, image correction is made as necessary (step S44).

After completion of the process for correcting the one divided area 72, whether an unprocessed divided area 72 exists or not is determined (step S45). When one or more unprocessed divided areas 72 exists, any of the unprocessed divided areas 72 is determined as a new correction target and the image thereof is corrected (steps S41 to S44). When image correction on all of the divided areas 72 is completed, the image process is finished.

As described above with reference to FIG. 10, the process of determining various parameters for the image correction of the divided area 72 including the metering area 71 is performed such that the process of obtaining the brightness of the area from the pixel values is omitted and the metering value used at the time of determining the exposure parameters is used. The number of computing steps in a whole correcting process are therefore reduced, and reduction in time required to correct the whole image is attained.

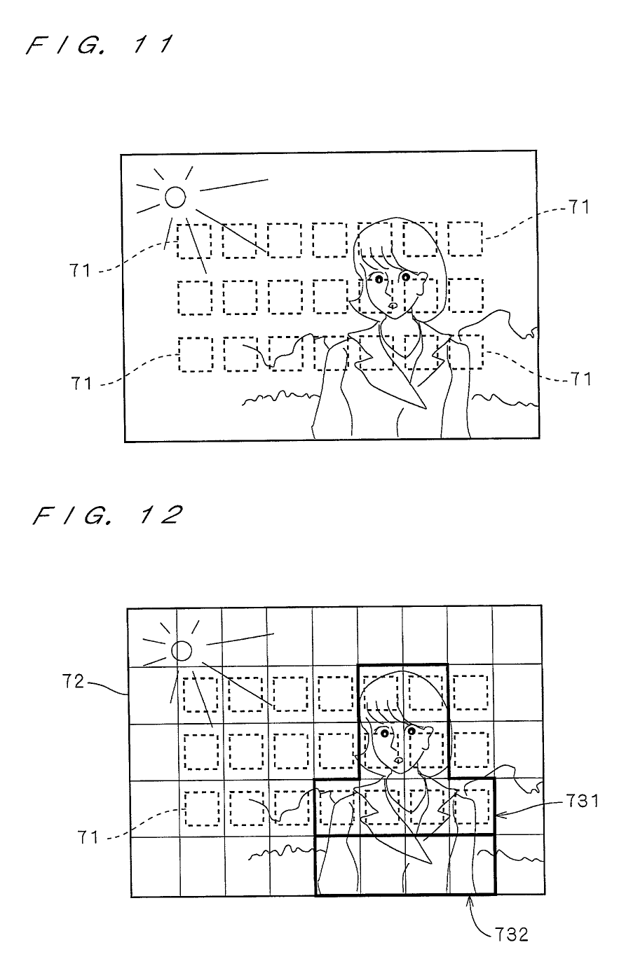

FIGS. 11 and 12 are diagrams for explaining a specific example of the processes shown in FIGS. 6 to 8 and FIG. 10. FIG. 11 shows the positions of the metering areas 71 at the time of capturing an image in a backlight environment. At the time of calculating the exposure parameters, since the metering value (brightness) of the metering areas 71 corresponding to the human are small, the determination result of “backlight” is derived by the scene determining section 311 in the exposure determining section 31 shown in FIG. 5 (step S13 in FIG. 6). The result of the scene determination for exposure and the metering value are stored as metering related information in the RAM 28 (step S15).

The information that the multi-area metering has been conducted is supplied from the metering section 27 to the correction controlling section 32. At the time of image correction, the correcting process determining section 321 switches the correcting process to the correcting process adapted to multi-area metering (step S23 in FIG. 7). To make image correction utilizing the metering value, the dividing section 322 divides the image into a plurality of divided areas 72 on the basis of the positions of the metering areas 71 as shown in FIG. 12 (step S311 in FIG. 8). The correcting section 26 determines whether image correction for backlight is necessary or not on each of the divided areas 72 by referring to the result of the scene determination for exposure. When it is determined that the image correction is necessary, image correction such as contrast enhancement or increase in brightness is made.

At the time of determining whether the correction for backlight is necessary or not by the correcting section 26, the metering value is used for each divided area 72 including the metering area 71. To be specific, when the metering value is small, it is determined that image correction for backlight is necessary. In each divided area 72 which does not include the metering area 71, whether image correction for backlight is necessary or not is determined from the values of the pixels included in the divided area 72. Finally, it is determined that the image of an area 731 surrounded by thick lines in FIG. 12 has to be corrected on the basis of the metering value. It is determined that the image of an area 732 surrounded by thick lines has to be corrected by performing a computing process on the pixel values. The divided areas 72 in the areas 731 and 732 are subjected to image correction (FIG. 10).

At the time of image correction as well, in the divided area 72 including the metering area 71, parameters for image correction such as the degree of contrast enhancement and the degree of increase in brightness are calculated on the basis of the metering value. In the divided area 72 which does not include the metering area 71, parameters for image correction are calculated from the values of pixels included in the divided area 72.

As described above, by determining the divided areas 72 each as a unit of image correction on the basis of the positions of the metering areas 71 in the multi-area metering, the metering value may be also used for the determination whether each image of the divided areas 72 has to be corrected or not and for the image correction of each divided area 72. Further, since the result of the scene determination for exposure is also used at the time of image correction, it is unnecessary to separately determine the scene for the correction. As a result, time required for the image correction can be reduced.

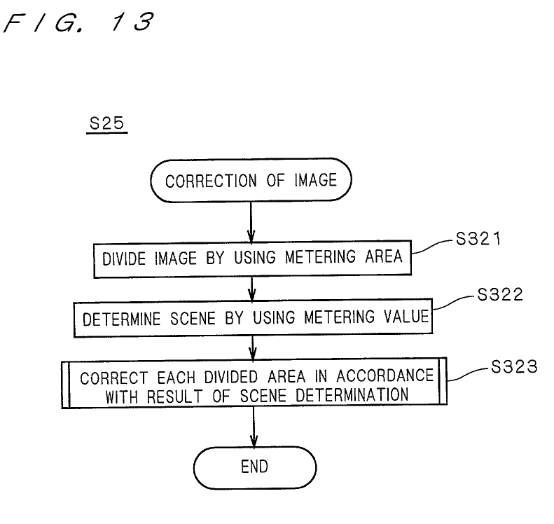

The processes shown in FIG. 8 are an example of using not only the result of the scene determination for exposure but also the metering value in the image correction. On the other hand, FIG. 13 is a flowchart showing the process of correction (step S25 in FIG. 7) in the case of using only the metering value as metering related information in the image correction.

Also in the case where only the metering value is used for correction, first, the dividing section 322 divides the image into the plurality of divided areas 72 by using the positions of the metering areas 71 as a reference as shown in FIG. 9 (step S321). Next, by using the metering value, the scene determining section 323 performs the scene determination for image correction (step S322). In the scene determination for image correction, various parameters are calculated on the basis of the brightness and hue of each of the divided areas 72, and the scene is determined in consideration of a difference between the parameters and those of another divided area 72. At this time, in the divided area 72 including the metering area 71, the metering value is used as it is as information of brightness. Consequently, the number of the computing steps in the scene determination for the image correction is reduced.

After that, in accordance with the result of the scene determination for image correction, as shown in FIG. 10, by using the metering value, each of the images of the divided areas 72 is corrected by the correcting section 26 (step S323). That is, in the divided area 72 including the metering area 71, determination of the necessity of the image correction and necessary correction are executed by using the metering value.

As described above, in the digital camera 1, the information indicative of the metering type used in image capturing is supplied to the correction controlling section 32. Which one of the correcting process adapted to the spot metering and the image correcting process adapted to the multi-area metering is used is determined by the correcting process determining section 321. Therefore, it is sufficient for the user to select the metering type by using the operation buttons 112 to conduct proper image correction.

In the case where the spot metering is carried out, the image correction is made by using the values of pixels corresponding to the metering area 71 a where the brightness is measurement. Consequently, image correction in which the intention of the user is reflected is realized.

In the correction where the multi-area metering is carried out, the result of the scene determination for exposure at the time of determining the exposure parameters and/or the metering value are/is used. Thus, the time required for image correction can be shortened, and the prompt process is realized.

2. Second Preferred Embodiment

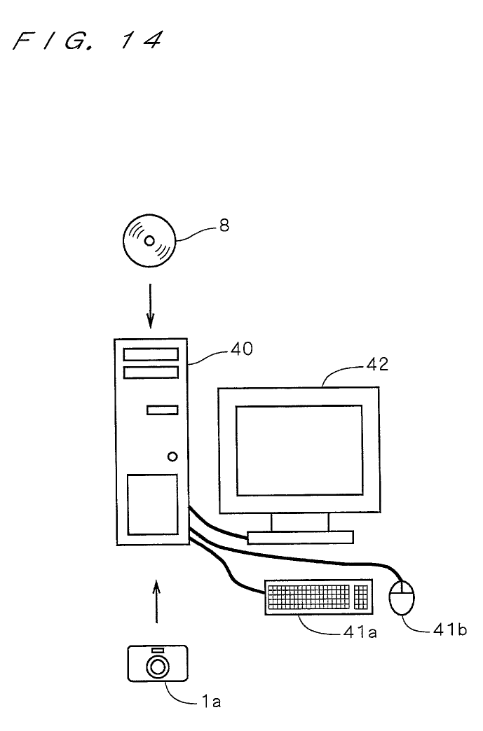

FIG. 14 is a diagram showing a computer 40 and its peripheral devices functioning as an image processing apparatus according to a second preferred embodiment of the invention. The computer 40 performs the correction of an image, which is made in the digital camera 1 in the first preferred embodiment. As shown in FIG. 14, a keyboard 41a and a mouse 41b for receiving an manual operation of the user and a display 42 for displaying various visual information for the user are connected to the computer 40. It can be also regarded that an image processing apparatus is constructed by those components.

Image data may be entered from a digital camera 1a via a memory card, a communication cable, and the like. The digital camera 1a has the configuration similar to that of an ordinary digital camera except that information of a metering type, a result of scene determination for exposure, a metering value, and the like used by the correction control section 32 shown in FIG. 5 can be outputted to the computer 40 via a memory card or the like.

In order make the computer 40 function as an image processing apparatus, a software program for correcting an image is installed in advance to the computer 40 via a recording medium 8 such as an optical disk, magnetic disk, magnetooptic disk, or memory card. A program may be installed via on-line computer communication through a network such as the Internet.

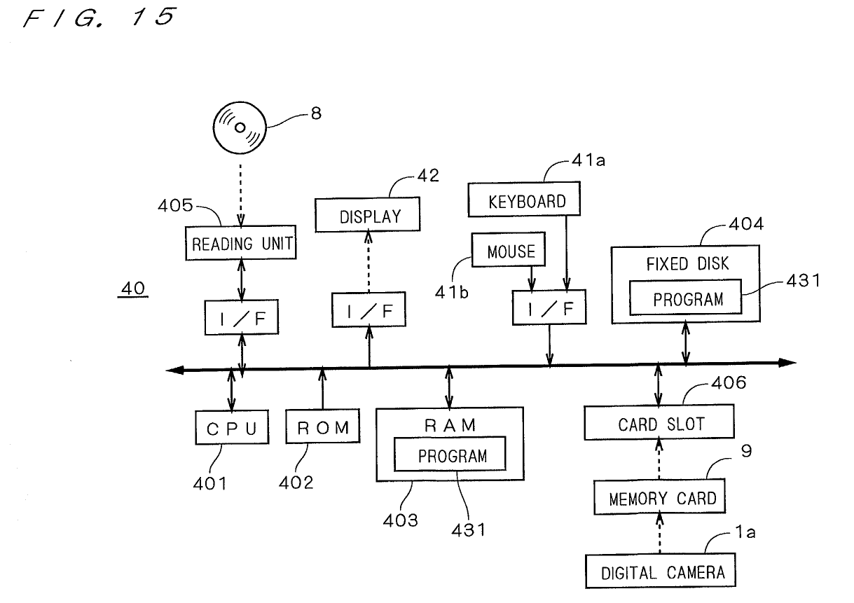

FIG. 15 is a block diagram showing the internal configuration of the computer 40 together with the peripheral devices. As shown in FIG. 15, the computer 40 has a configuration similar to that of an ordinary personal computer, in which a CPU 401 for performing various computing processes, a ROM 402 for storing a basic program, a RAM 403 for storing a software program for image correction or serving as a work area of a computing process, and the like are connected to a bus line. To the bus line, peripheral devices such as the display 42, a fixed hard disk 404 for storing various software programs including the program 431 for image correction, a reading section 405 for reading a software program and the like from the recording medium 8, a card slot 406 for transferring image data to/from the digital camera 1a via the memory card 9, and the keyboard 41a and mouse 41b for receiving an entry from the user are connected via interfaces (I/F) as appropriate.

The program 431 for image correction is loaded via the reading section 405 (or a communication section separately provided in the case of loading the program 431 through network communication) to the hard disk 404 and is copied to the RAM 403. When the CPU 401 performs the computing process in accordance with the program 431, the computer 40 functions as an image correcting apparatus.

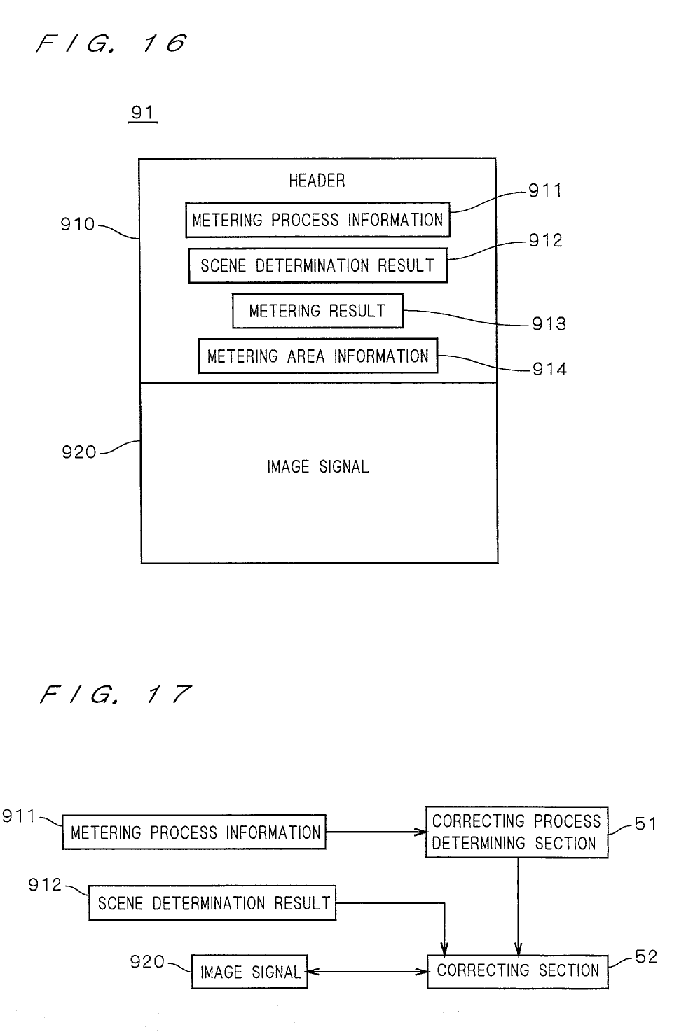

FIG. 16 is a diagram showing the structure of image data 91 captured by the digital camera 1a. The image data 91 is comprised of a header 910 for storing various information regarding the captured image and an image signal 920 indicative of the body of the image data. The header 910 includes:

1) information 911 indicative of the type of the metering process used at the time of capturing the image (hereinbelow, called “metering process information”);

2) result 912 of scene determination for exposure (hereinbelow, called “scene determination result”) used at the time of determining the exposure parameters;

3) a metering result 913 as a metering value; and

4) metering area information 914 as information of the position of the metering area 71, which may include information of size and shape the metering area 71, shown as an example in FIG. 11.

As shown in FIG. 16, the metering related information, information of the metering and the like, which is erased after completion of image correction in the digital camera 1 according to the first preferred embodiment, is stored as well as an image signal in the digital camera 1a according to the second preferred embodiment. Only information necessary for the computer 40 to correct the image according to the kind of image correction may be properly included in the header 910.

According to the format of an image file, elements of the information whose storage location is reserved are stored in the location, and other elements of the information whose storage location is not reserved are stored in the user area. For example, for file formats such as Exif (Exchangeable image file format) and DCF (Design rule for Camera File system) obtained by expanding the Exif, storage locations of the metering process information 911 are reserved. The scene determination result 912, metering result 913, and metering area information 914 are stored in the user area in the header 910.

FIGS. 17 to 19 are block diagrams showing the functional configuration of the computer 40 in the case of processing the image data 91 having the data structure shown in FIG. 16 by the computer 40. In the diagrams, a correcting process determining section 51, a correcting section 52, a dividing section 53, and a scene determining section 54 correspond to the functional components realized by the CPU 401, ROM 402, RAM 403 and the like in FIG. 15. Processes realized by the functional components are those in steps S23 to S25 in FIG. 7.

The image data 91 transferred from the digital camera 1a is stored in the RAM 403. In FIGS. 17 to 19, information transferred between the various functional components and the RAM 403 is also properly shown.

FIG. 17 shows the functional configuration in the case where only the metering process information 911 and the scene determining result 912 are used to correct an image (to be accurate, the image signal 920) in the computer 40. In FIG. 17, the correcting process determining section 51 obtains the metering process information 911, checks that the metering type used at the time of image capturing is either spot metering or multi-area metering, and determines an image correcting process in accordance with the metering type (corresponding to step S23).

In the case where the metering process information 911 indicates the spot metering, the above-described image correction for spot metering is made (corresponding to step S24). In the case where the metering process information 911 indicates the multi-area metering, the correcting section 52 corrects an image by using the scene determination result 912 (corresponding to step 25).

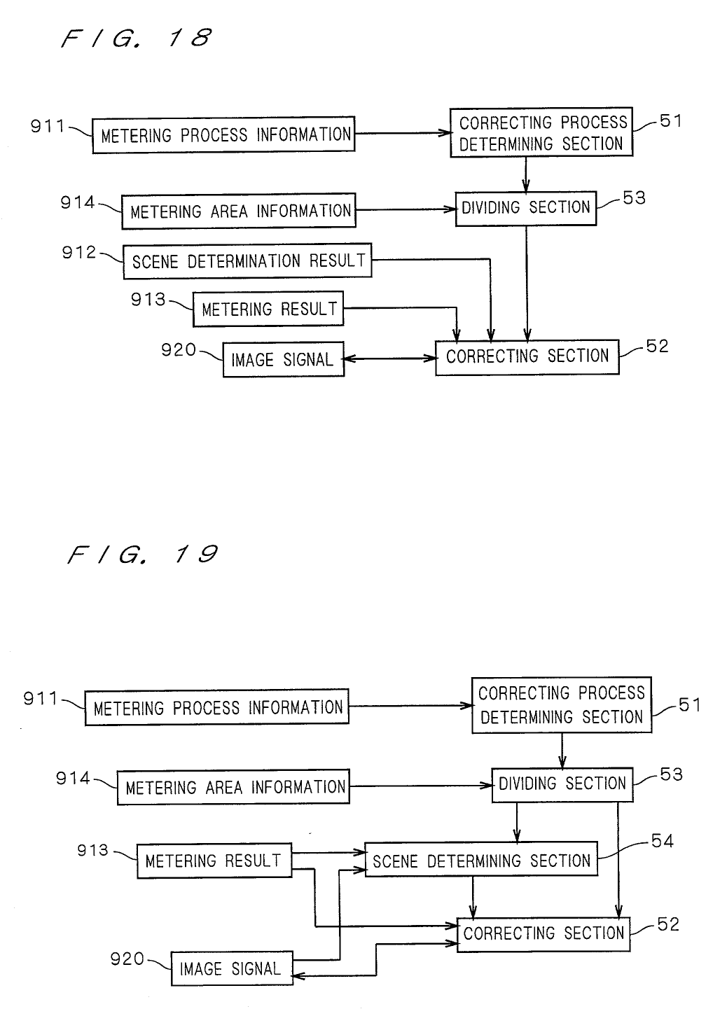

FIG. 18 shows the functional configuration in the case where the computer 40 corrects an image by using the scene determination result 912, metering result 913, and metering area information 914 when the metering process information 911 indicates the multi-area metering, that is, when the processes shown in FIGS. 8 and 10 are performed by the computer 40.

In FIG. 18, first, the correcting process determining section 51 obtains the metering process information 911 and selects an image correction adapted to multi-area metering (corresponding to step S23). On the basis of the metering area information 914, the dividing section 53 divides an image (step S311). In the dividing section 53, information indicative of the size of an image in the header 910 is also supplied. After that, the correcting section 52 executes the correction of each image of the divided areas on the basis of the scene determination result 912 and the metering result 913 (step S312 in FIG. 10).

FIG. 19 shows the functional configuration in the case where the computer 40 corrects an image on the basis of the metering result 913 and metering area information 914 when the metering process information 911 indicates the multi-area metering, that is, when the processes shown in FIGS. 13 and 10 are performed by the computer 40. In FIG. 19 as well, the correcting process determining section 51 obtains the metering process information 911 and selects an image correction adapted to multi-area metering (corresponding to step S23). On the basis of the metering area information 914, the dividing section 53 divides an image (step S321). The scene determining section 54 performs scene determination for image correction on the basis of the metering result 913 (step S322), and the correcting section 52 executes the correction of each image of the divided areas on the basis to the result of the scene determination for image correction and the metering result 913 (step S323 in FIG. 10).

As described above, the image correcting process in the first preferred embodiment may be performed also by the computer 40, thereby enabling image capturing in the digital camera to be promptly performed. By executing the above-described image correction by using the computer 40, in a manner similar to the first preferred embodiment, proper correction according to the metering is realized. In the case where the multi-area metering is performed, the scene determination result 912 and the metering result 913 used for determining the exposure parameters are also used for image correction, so that the time required for image correction can be shortened.

3. Modifications

In place of the metering using the CCD 23, a plurality of dedicated metering devices provided in the digital camera 1 may be used for metering. In this case, the metering areas 71 are determined by using the correspondence of each metering device to each area in the image capturing range.

A metering type other than the spot metering and the multi-area metering may be also employed. For example, averaging metering in which an average of brightness of a whole image capturing range is calculated may be used. In the case of the averaging metering, an image correcting process for averaging metering is selected by the correcting process determining section.

In place of performing the spot metering only in the center metering area 71a in the image capturing range, the area for the spot metering can be changed according to the position of the main subject. In the case of a method of performing metering while weighting the metering value in a specific metering area 71 such as centerweighted metering, the image correction for spot metering can be used.

In place of using the result of the scene determination for image correction, which is led from the metering value in the multi-area metering, other information may be used as information led from the metering value, i.e., so-called AE determination information.

In the above description, in the case where the multi-area metering is performed and the metering value is used, an image is divided on the basis of the positions of the metering areas 71. However, at the stage of step S322 in FIG. 13, an image may not yet be divided. For example, it is also possible to calculate an average value of brightness in the center area of the divided area 72 which does not have the metering area 71 in FIG. 12 and perform scene determination for image correction by using the average value and the metering value.

A gap may not exist between neighboring metering areas 71. In the case of performing metering by using the CCD 23, the size and shape of the metering area 71 can be freely changed in a software manner. The metering area 71 and the divided area 72 may coincide with each other. In this case, at the time of image correction, the metering value can be more properly used.

In the image processing apparatus in the second preferred embodiment, all or a part of the function components shown in FIGS. 17 to 19 may be realized by a dedicated electric circuit(s).

The invention can be applied not only to the digital still camera in the preferred embodiments but also a digital movie camera.

While the invention has been shown and described in detail, the foregoing description in all aspects illustrative and not restrictive. It is therefore understood that numerous other modifications and variations can be devised without departing from the scope of the invention.

What is claimed is:

1. A digital camera comprising:
an image pickup device for capturing an image of a subject;
an exposure determining element for determining exposure parameters in image capturing;
a selector for selecting a metering process for determining said exposure parameters; and
a corrector for correcting said image through a correcting process according to a type of said metering process selected by said selector.

2. The digital camera according to claim 1, wherein
said corrector is operable to correct said image on the basis of values of pixels correcting to a specific area within an image capturing range, when said metering process selected for said image is a first metering type in which brightness in said specific area is weighted within said image capturing range.

3. The digital camera according to claim 1, wherein
said corrector is operable to correct said image on the basis of either a result of said metering process or information lead from said result of said metering process, when said metering process selected for capturing said image is a second metering type in which a plurality of areas within the image capturing range are metered.

4. The digital camera according to claim 3, wherein
said exposure determining element determines a relation between a distribution of brightness in said image and said subject on the basis of said result of said metering process to make scene determination, and
said corrector corrects said image on the basis of a result of said scene determination.

5. A digital camera comprising:
an image pickup device for capturing an image of a subject;
an exposure determining element for determining exposure parameters in image capturing;
a meter for performing metering process in determination of said exposure parameters in which brightness in a specific area is weighted within an image capturing range; and
a corrector for correcting said image on the basis of values of pixels corresponding to said specific area.

6. A digital camera comprising:
an image pickup device for capturing an image of a subject;
an exposure determining element for determining exposure parameters in image capturing;
a meter for performing metering process in determination of said exposure parameters in which a plurality of areas in an image capturing range are metered;
a divider for diving said image into a plurality of divided areas on the basis of positions of said plurality of areas; and
a corrector for correcting each of said plurality of divided areas individually by using a result of said metering process or information led from said result of said metering process.

7. An apparatus for processing an image, comprising:
a first element for determining a metering type used in capturing said image from image data including said image and determining a correcting process in accordance with said metering type; and
a second element for correcting said image through said correcting process.

8. A method of processing an image, comprising the steps of:
determining a metering type used in capturing said image and determining a correcting process in accordance with said metering type; and
correcting said image through said correcting process.

9. A recording medium on which a software program for allowing a computer to process an image is recorded, wherein said software program allows said computer to execute the steps of:
obtaining a metering type used in capturing said image from image data including said image and determining a correcting process in accordance with said metering type; and
correcting said image through said correcting process.

10. An image processing system comprising:
an image camera for capturing an image of a subject;
a metering device for metering said subject for exposure control at capturing, and provided with a plurality of metering processes;
a program storage for storing a plurality of image-correction programs previously related to the metering processes, respectively;
a selector for selecting a metering process among said plurality of metering processes to activate said metering device in accordance with said metering process selected: and
an image-corrector for correcting said image according to an image-correction program previously related to said metering process.

11. An image processing system comprising:
an image camera for capturing an image of a subject;
a metering device for metering said subject to generate a metering information for exposure control; and
an image-corrector for correcting said image in response to said metering information obtained in said metering device.
